(19) United States
(12) Patent Application Publication
(10) Pub. No.: US 2002/0052775 A1
(43) Pub. Date: May 2, 2002

(54) Method and system for generating, displaying, and manipulating a marketing model

(76) Inventors: John W. Fisher JR., Westminster, CO (US); Paul H. Riesberg, Johnstown, CO (US); Jason A. Thomas, Arvada, CO (US); Mark Walton, Lafayette, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/785,062

(22) Filed: Feb. 16, 2001

Related U.S. Application Data
(63) Continuation-in-part of application No. 09/697,657, filed on Oct. 26, 2000.

(51) Int. Cl. G06F 17/60

(52) U.S. Cl. 705/10

(57) ABSTRACT

A system, method and software application for generating, implementing and managing a multi-activity marketing plan are described. Such a marketing campaign can include various campaigns, programs and tactics interrelated in a tree-like structure. One method of the present invention includes a software application that permits a user to build and manage a marketing plan through the use of marketing objects.

### PRIORITY

This application is a continuation-in-part of U.S. patent application Ser. No. 09/697657, Attorney Docket No. TACT-001/00US, entitled Method, Apparatus And Software Application For Generating, Implementing And Managing A Multi-Activity Marketing Plan, filed on Oct. 26, 2000, which is incorporated herein by reference in its entirety.

### FIELD OF THE INVENTION

The present invention relates to systems, methods and computer applications for resource and task management and in particular, but not by way of limitation, to systems, methods and computer applications for development, analysis and management of resources involved in multi-activity marketing plans.

### BACKGROUND OF THE INVENTION

Recent improvements in processing technology have created a climate in which most business systems and processes are implemented by automated, integrated business computer systems. The increased computing power of these new systems allows business, for the first time, to model complex projects and thereby more effectively plan, implement, manage and analyze those projects. The savings in time and cost that companies are realizing due to these integrated business systems has led them both to expect and demand such systems.

Although the benefits of integrated business planning systems are well known, certain functions in businesses have yet to develop any useful integrated planning system. For example, the complexities of the marketing field have, to date, thwarted any efforts to develop an integrated, computerized marketing system. Rather, present computerized marketing systems focus on singular marketing activities. That is, present marketing systems are designed to aid the marketing professional in implementing a single marketing tactic such as direct mailing or telemarketing. Unfortunately, if the overall marketing plan requires multiple activities (e.g., both direct mail and corporate sponsorships), a second, unrelated planning system, if even available, must be used. These singularly focused computerized applications leave the overall integration of the individual marketing activities to the skill of the marketing professional and, unfortunately, leave the marketing professional without any computerized tools to aid in that integration.

By being forced to utilize different, unrelated software applications to implement the various marketing activities involved in a single marketing plan, a disconnect is created between the overall goals of the marketing plan and the various activities used to implement that plan. Although each individual activity may be implemented with great expertise, the present computerized marketing systems allow no way to create, manage, implement and/or analyze the combined activities of the marketing plan. In essence, present systems require that each marketing activity be implemented in a vacuum without regard for any other activities. This inability to correlate the various activities of a marketing plan often results in the implementation of overlapping activities, the opportunistic selection of activities and the overlooking of certain beneficial activities. Accordingly, present marketing systems and methods result in unnecessary costs, missed opportunities and delayed marketing plan implementation.

A system, method and computer software application, thus, are needed to overcome the above-described and other known deficiencies in the present technology. For example, a system, method and software application are needed to create, implement, manage, and/or analyze a multi-activity marketing plan. Additionally, a system, method and software application are needed for identifying an optimal marketing plan through the selection of various marketing activities. Such a holistic invention could reduce a marketing plan's cost per impression, increase the marketing plan's effectiveness (percent of target audience reached), speed the implementation of the marketing plan, and allow for sophisticated personnel and resource management.

### SUMMARY OF THE INVENTION

To remedy the above-described and other deficiencies of the current technology, a system, method and software application for generating, implementing and managing a multi-activity marketing plan have been developed. In one of the various embodiments, the present invention includes a software application for generating an entire marketing plan that can include various campaigns, programs and tactics interrelated in a tree-like structure. That is, the marketing plan could be the root of the tree, the campaigns the first level, the programs the next level, and the tactics the bottom sub-level. A conceptual view of this structure can be seen in FIG. 5, which is described in detail herein. For the purposes of this document, the “marketing plan” is the strategic, integrated view of the marketing activities around a defined product. A “campaign” is the overall marketing objective for a portion of the marketing plan. A “program” is an organizational placeholder for multiple activities centered on a specific objective of a campaign, and a “tactic” is a discrete method, means and mode of marketing.

Utilizing the software application in accordance with the principles of the present invention, each level of the marketing plan is fully customizable. Moreover, each level can be associated with specific parameters. For example, an overall budget for the entire plan can be established. Likewise, a budget for each campaign, a budget for each program, and a budget for each tactic can be established. Additionally, the user can establish timetables for each level of the marketing plan. Each of these budgets and timetables can be stored for subsequent retrieval and manipulation.

Once the user has defined the entire marketing plan, data can be drawn from a database of historical marketing information and used to predict the results of the plan. That is, the software application of the present invention can predict, for example, the percent of the target audience that will be reached, the overall costs of implementing the marketing plan, and/or the chance of implementing the marketing plan in a timely manner. This predictive information can be used to adjust the plan and to run a series of hypothetical, alternate marketing plans based upon the product lifecycle or a single phase of the product lifecycle. After an optimal plan is identified and created, the software application of the present invention can guide the user through the steps necessary to implement the various tactics included in the plan. In one embodiment, the software application displays a series of selectable steps for each tactic. The user can expand any one of the steps to view the various actions that make-up the tactic. (Actions can include both actions and decisions.) The user can then assign each action to an individual and also can assign a start/end date for each action. These assignments are stored for subsequent use in managing the marketing plan.

As the individual actions of the marketing plan are started or completed, this information, along with any cost information, is recorded in association with the appropriate action. If an action is behind schedule or over budget, this fact is also recorded. For any delayed action, all actions, steps, tactics, programs and campaigns that will be impacted are identified, and the scope of the impact is calculated. When necessary, impacted elements of the marketing plan can be electronically rescheduled to adjust for the delayed action. Similarly, budget resources can be electronically adjusted to compensate for any actions that go over budget.

One particular embodiment of the present invention permits a marketing plan to be constructed, viewed and managed through a graphical interface called a market model. A market model can be constructed by selecting and adding marketing objects to a market plan template. As these marketing objects are added, dependencies can be automatically established. Moreover, management objects can be associated with various marketing objects to thereby generate graphical representations of timeliness, effectiveness and cost overruns.

In further embodiments, the unique demographics and psychographics of the target audience can be effectively modeled to aid in the development of marketing strategies and positioning throughout the corporate/product lifecycle. Also, the unique tactics of the marketing plan can be modeled against the steps in the marketing process to determine optimal effectiveness of marketing activities.

In summary, embodiments of the present invention provide a system, method and software application for creating an integrated, multi-activity marketing plan, implementing that plan, and managing that plan. Other embodiments provide additional features including, but not limited to, systems for analyzing the plan and systems for generating an optimal plan based upon collected marketing results. These, as well as other embodiments, are described herein in detail.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a flowchart of the basic method of operation of the present invention;

FIG. 2 is a detailed flowchart of the step of generating a marketing plan as shown in FIG. 1;

FIG. 3 is a detailed flowchart of the step of implementing a marketing campaign as shown in FIG. 1;

FIGS. 4A-4C are detailed flowcharts of various implementations of the step of managing the marketing plan as shown in FIG. 1;

FIG. 5 illustrates an exemplary data architecture diagram in accordance with the principles of the present invention;

FIG. 6 is a block diagram of the modules used to implement the methods shown in

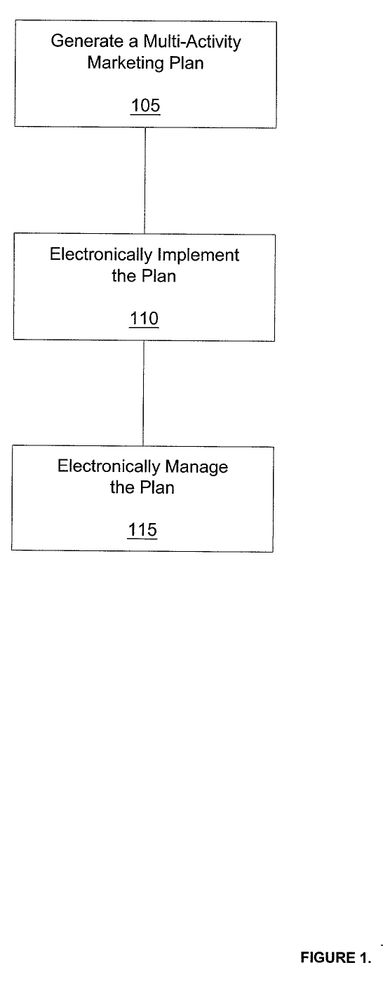

FIGS. 1-4C;

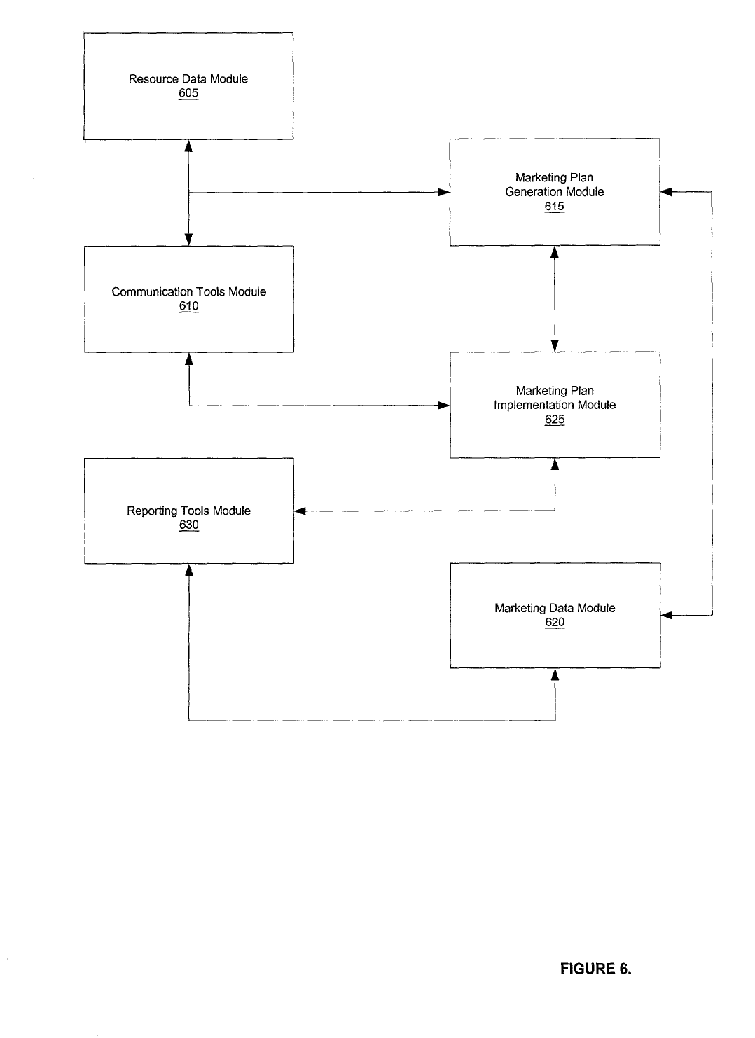

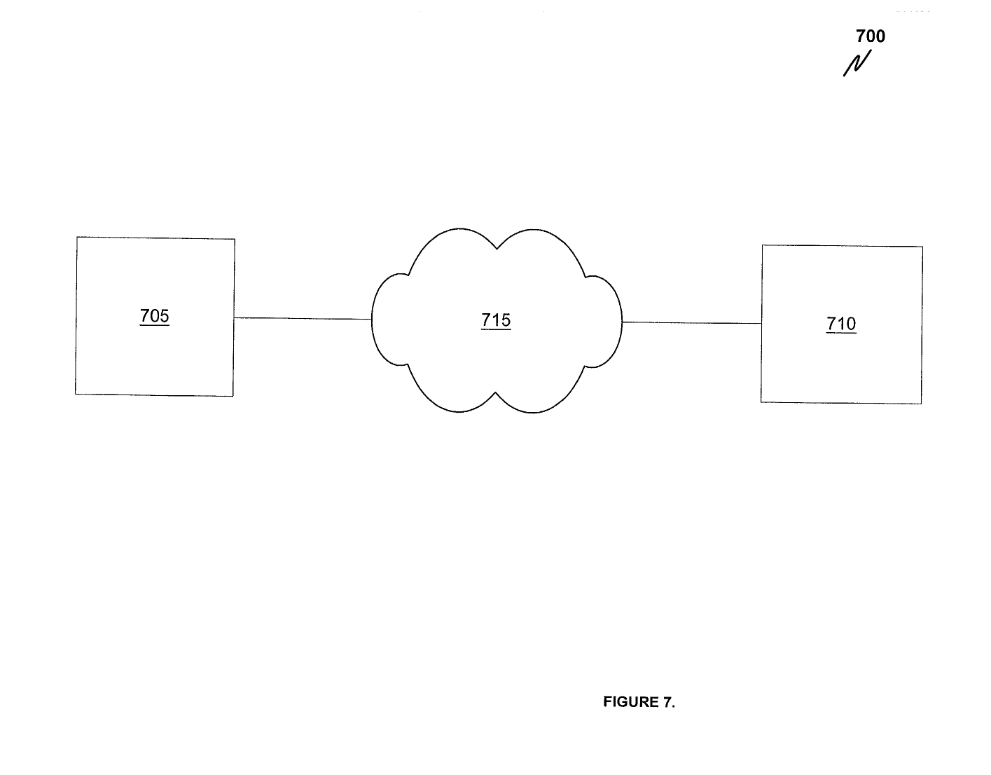

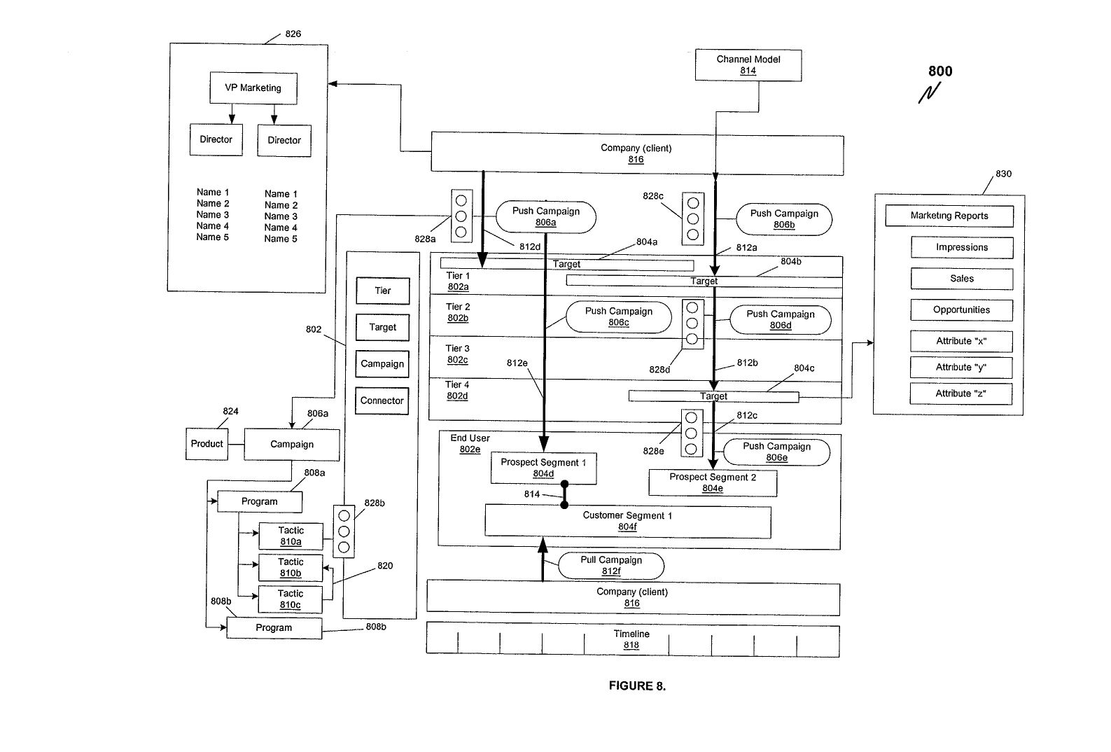

FIG. 7 is an exemplary hardware system for implementing the modules of FIG. 6; and

FIG. 8 illustrates a market model constructed in accordance with the principles of the present invention.

### DETAILED DESCRIPTION

Although the present invention is open to various modifications and alternate constructions, a preferred exemplary embodiment that is shown in the drawings is described herein in detail. It is to be understood, however, that there is no intention to limit the invention to the particular forms disclosed. One skilled in the art can recognize that there are numerous modifications, equivalents and alternative constructions that fall within the spirit and scope of the invention as expressed in the claims.

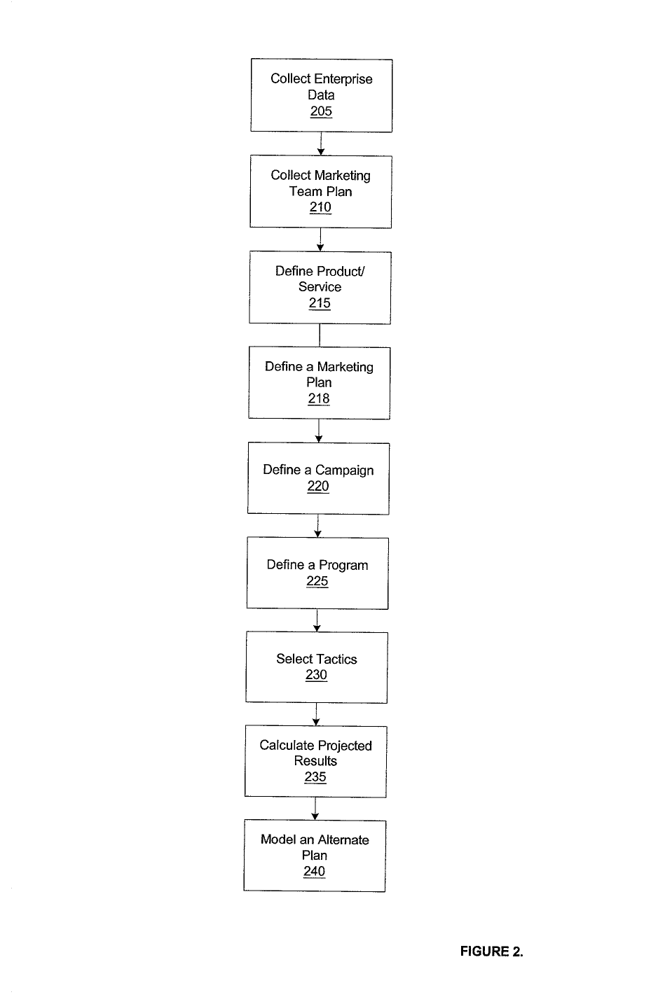

Referring now to FIG. 1, there is illustrated a high-level flowchart for generating, implementing, managing and analyzing a multi-activity marketing plan. This high-level method includes three basic steps that are described in greater detail with relation to FIGS. 2, 3 and 4A-4C. As those of skill in the art can recognize, the steps described in FIGS. 1-3 and 4A-4C are designed to be implemented, at least in part, by a software application running on an appropriate computer system. This computer system could be virtually any type of system. The presently preferred embodiment, however, is implemented on architectures that support Microsoft® Windows™.

Still referring to FIG. 1, the initial step in this embodiment of the present invention is to generate a marketing plan (Step 105). Through the use of a computer system, this marketing plan can be generated by iterations of optimizing steps that account for variables such as budget, personnel, time constraints, projected percent of target audience reached, marketing goals, marketing tactics, type of target audience, etc. These variables can be adjusted so that the associated software application can generate an optimized marketing plan. Notably, the software application of the present invention gives a marketing professional, for the first time, the ability to see in real time the impact that changing one variable will have on the other variables. For example, if one of the tactics for the marketing plan is changed from advertising in a magazine to advertising on TV, the software application of the present invention can compute and display the impact on the budget, overall time table, impressions, other tactics and the like. By being able to model the entire marketing plan in such a holistic manner, the present invention offers a significant advantage over the present computerized marketing systems, which merely model single marketing activities and lack the ability to correlate tactics, programs and campaigns.

Still referring to FIG. 1, after the marketing plan has been generated, the next step is to implement the plan (Step 110). In one embodiment of the present invention, the software application guides the marketing professional through a set of default steps (although fully customizable) suggested for implementing the generated plan. These steps can be broken down into a finer resolution, (which include both actions and decisions, collectively called “actions”), and each action can be associated with a start/end date field and a responsible personnel field. These start/end date fields and personnel assignment fields can be automatically populated with default settings based upon known personnel resources and timetables.

Any conflicts between the start/end dates of the various actions, as well as any personnel assignment conflicts, can be electronically identified and reported. For example, a notification can be generated if the established schedule requires that the direct mail pieces be mailed prior to the date that those pieces will be delivered from the printer. In yet another embodiment, a marketing history database can be accessed to determine the feasibility of the start/end dates for the various assignments. For example, a notification, can be generated when the action of printing the mail pieces is scheduled to take only one day when prior experience suggests that the printing should take four days. Finally, when all actions have been assigned and all conflicts have been resolved, the marketing plan can be finalized and the assignments automatically distributed to the appropriate personnel through electronic messaging, calendar entries, etc.

As the marketing plan is being implemented, its progression can be monitored, managed and dynamically adjusted (Step 115). In one embodiment, each of the various actions is monitored for timeliness and cost overruns. If a particular action is not timely performed, or will likely not be timely performed, this fact is reported. Additionally, the impact that one delayed action will have on other elements of the marketing plan—including ability to achieve sales goals—can be electronically calculated. For example, if the printer is two weeks late in delivering a mail piece for a direct mail campaign, the action of mailing those pieces will obviously be set back two weeks. Thus, the entire direct mail tactic also will be set back two weeks. Assuming that the overall marketing plan requires telemarketing calls to be made to those who respond to the direct mail tactic, the telemarketing tactic will likewise be set back two weeks. This setback, in turn, could impact the start date of some other tactic included in the marketing plan. To deal with these interrelated delays, one embodiment of the present invention automatically reschedules the impacted elements to compensate for the delayed action. For example, any impacted personnel could have their electronic calendars updated to reflect the new schedule.

Accordingly, embodiments of the present invention not only report the timeliness of particular actions, but they also project the impact that delayed (and over budget) actions will have on the entire marketing plan and any ability to achieve the sales goal. Additionally, embodiments of the present invention can suggest corrective measures to resolve any detected problems. For the first time, the progression of an entire marketing plan, rather than just a single marketing activity, can be monitored and dynamically adjusted. The result of this new capability is the efficient, rapid and cost effective generation and implementation of complicated marketing plans.

Although the preferred embodiment implements each of the steps 105, 110 and 115, one skilled in the art can recognize that each step and the systems that implement those individual steps are improvements over the current technology. Moreover, each step (and associated system) in itself satisfies a long felt need in the marketing industry for sophisticated marketing tools.

Referring now to FIG. 2, it is a more detailed flowchart of the step of generating a marketing plan (Step 105) shown in FIG. 1. As those skilled in the art can recognize, these steps, at least in part, are meant to be executed by a software application. Moreover, although the marketing plan generation step of FIG. 1 can be implemented in a variety of ways, particularly good results have been achieved with software applications that perform the steps shown in FIG. 2.

In this embodiment, basic company (the company being the client that is developing a marketing plan) and product/service (the product/service that will be marketed) information is electronically collected and stored (Step 205). For example, information about corporate personnel, payment channels, contact information, reporting relationships and the like can be collected and stored (Step 210). Similarly, information about the marketing team can be collected and stored. The marketing team information can include personnel, roles, reporting relationships, areas of expertise, authorities, etc. This marketing team information can subsequently be used to assign the proper personnel to particular actions. As stated above, the attributes of the product/service being marketed can also be collected (Step 215). Such product/service information can be used to create financial models, identify target audiences, implement certain actions, etc. Although the information about the company, marketing team and product can be collected in a variety of ways, the presently preferred implementation involves the use of graphical wizards that guide a user, step-by-step, through the information collection process.

After the basic information is collected in steps 205-215, a marketing plan for the defined product is electronically established (Step 218). (As previously defined, the “marketing plan” is the strategic view of the marketing activities around the defined product.) For example, a marketing plan could involve launching a new product. Depending upon the segmentation of marketing dollars, a company may have several marketing plans being implemented simultaneously. A car company, for example, might have a first marketing plan for a first car and a second marketing plan for a second car. Each of these plans would likely have its own budget and timetable.

After the marketing plan has been established, the campaign(s) associated with that plan should be created (Step 220). A created campaign should have an objective such as sales, recruiting, awareness, or lead generation. Notably, several campaigns can be created for a single marketing plan. Moreover, each campaign can be assigned a budget and a timetable. If the combined budget of the various campaigns conflicts with the budget for the entire marketing plan, an appropriate electronic notification can be generated. Likewise, if the timetables of the various campaigns conflict with each other or if the combined timetables of the campaigns conflict with the overall marketing plan's timetable, an appropriate electronic notification can be generated.

Next, one or more programs can be defined for each campaign (Step 225). For example, a campaign might be defined as a sales campaign intended to sell a new prescription drug. A first program in this campaign could be a “push” program that actively targets doctors through medical equipment sales representatives. That is, doctors would be contacted about the new drug through a business partner. The second program under the same sales campaign could be a “pull” campaign targeted directly at the doctors to cause them to take some action. Each of these two programs would be associated with tactics designed to achieve the intended purpose. As with the campaigns, a budget and timetable can be established for each program. Because the various programs and their attributes can be electronically stored, the present invention can electronically determine if the combined budgets of the programs conflict with the campaign budget or if the timetables of the various programs conflict with each other.

Still referring to FIG. 2, the tactics for each program should be selected after the programs have been defined (Step 230). Tactics include, but are not limited to, direct marketing, telemarketing, email, fax flyers, newsletters, events, TV ads, catalog ads, magazine ads, banner ads, outdoor ads, radio ads and sponsorships. Additionally, each tactic can be electronically associated with information items such as projected number of impressions, projected response rates, projected conversion rates, etc. These informational items may vary according to the product/service being marketed. For example, the projected response rate for a prescription drug could be low when a telemarketing campaign is used. However, the projected response rate for a newspaper subscription drive could be high when that same type of telemarketing campaign is used. In further embodiments, each tactic can be associated with a budget and a timetable that can be electronically compared against the program, campaign, and/or overall marketing plan's budget and timetable to guarantee that the overall requirements of the marketing plan are being achieved.

After the tactics for each program have been selected (Step 235), the overall marketing plan can be modeled by the software application of the present invention to determine the plan's effectiveness and/or practicality. For example, the number of sales due to the marketing plan and the costs per impression can be electronically projected and modeled against the sales goals to determine optimal marketing effectiveness. Additionally, psychographics and demographics can also be modeled to determine audience size and appropriate market selection. Other data points that can be modeled include the projected percent of target audience reached and the projected implementation difficulties. If the model of the market plan is not satisfactory, various portions of the plan can be modified and the plan can be remodeled (Step 240). In essence, a series of “what if” scenarios can be run to find an optimal marketing plan. These scenarios allow resources to be redistributed within the existing plan's structure, i.e., budgets to be shifted, the scenarios also allow entire new marketing plan structures to be created wherein new campaigns can be defined, new programs created, and/or new tactics selected.

In one embodiment, the present invention can aid the user in finding the optimal marketing plan. Through a series of computerized, iterative steps using information about the defined goals of and the resources available to the marketing plan, the present invention can identify the optimal marketing plan. Moreover, this optimal marketing plan could be generated based upon a set of assumptions about the effectiveness of various marketing tactics for the particular product/service being marketed. This embodiment also allows the degree of optimization to be adjusted to focus on particular levels of the marketing plan. That is, the level of optimization can be limited to the tactic level, to the tactic and program levels, or to the tactic, program and campaign levels.

Whether the optimal marketing plan is generated automatically or through a set of user driven, iterative processes, the end result is a defined marketing plan that is broken down into campaigns, programs, and tactics—although other levels can be defined. These manageable components allow marketing professionals, with the aid of a computer system, to holistically view an entire marketing plan rather than just individual marketing activities. Moreover, these manageable components permit simplified computerized implementation and management of an otherwise complicated project.

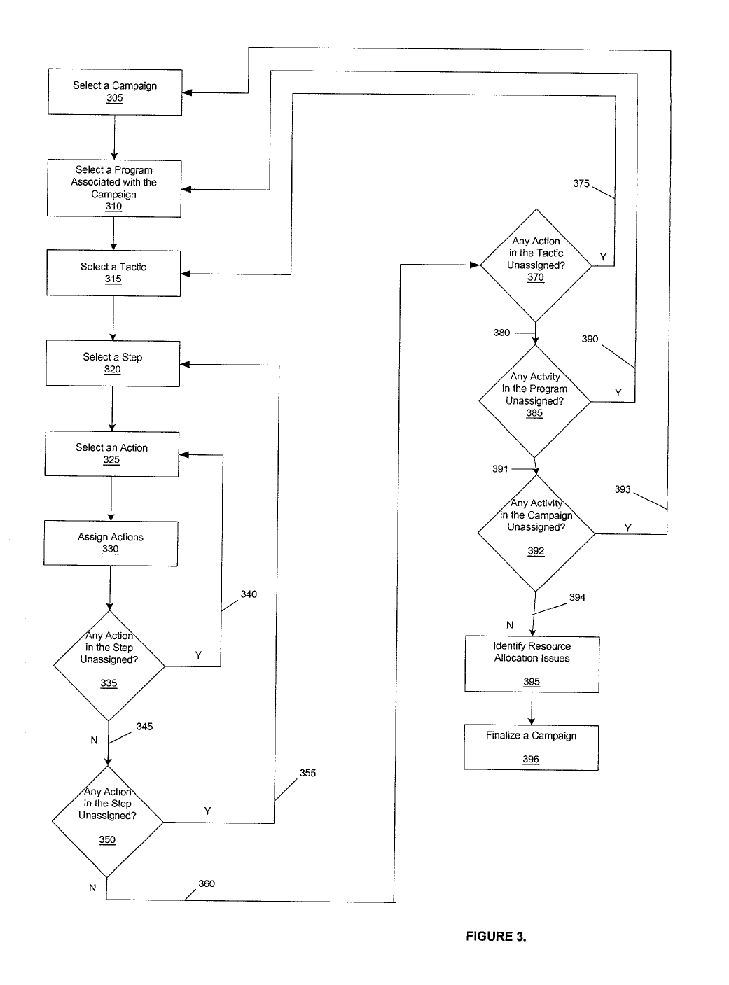

Referring now to FIG. 3, there is illustrated a detailed flowchart of the market plan implementation step 110 shown in FIG. 1. As one skilled in the art can recognize, these steps can be implemented by a typical computer system. In this method, a campaign, a program corresponding to that companies and a tactic corresponding to that program are selected (Step 302, 310, 315). For the selected tactic, a default list of steps suggested for implementing to that tactic can be displayed. Additionally, once a particular step corresponding to the related tactic is chosen from the list (Step 320), a list of default actions necessary to complete the step can be displayed (Step 325). Each action can then be assigned, either manually or automatically, to a particular person and can be assigned a start/end date (Step 330). That is, the assignment and date fields can be populated either manually or automatically. For example, if a particular action requires an expertise that only one person in the marketing department possesses, that person could be assigned automatically responsibility for that action.

If the software application of the present invention determines that all actions for a step have been properly assigned (both personnel and dates) (Step 335), then branch 345 can be followed. Otherwise, branch 340 is followed and the next action for the current step is selected and assigned. Next, it is determined whether any step in the current tactic includes unassigned actions(Step 350). If any actions remain unassigned, branch 355 is followed until all actions in all steps of the presently selected tactic are properly assigned. Once all actions in all steps of a single tactic are assigned, branch 360 is followed and a determination is made as to whether any of the tactics include unassigned steps/actions. If yes, branch 375 is followed and each action of each step for each tactic is assigned. If no, branch 380 is followed, and a determination is made as to whether there are any programs that include unassigned activities (Step 385). If yes, branch 390 is followed and each action (of each step of each tactic of each program in the presently selected campaign) is assigned. If all actions associated with each program of the presently selected campaign have been assigned branch 391 is followed, and a determination is then made as to whether any campaign includes unassigned actions. If yes, branch 393 is followed and each activity for the campaign is assigned (Step 392). If no, branch 394 is followed. At this point each action necessary to implement the entire marketing plan has been assigned.

After all actions for all steps, tactics, programs and campaigns have been assigned, resource allocation issues, whether actual or projected, can be identified (Step 395). For example, conflicting start/end dates for the various actions can be identified. Additionally, personnel issues, such as conflicting work assignments, can be identified. Once identified, steps to correct the problems can be suggested, and those in charge of implementing the marketing plan can make the necessary adjustments to create a final implementation that can be distributed to the marketing team (Step 396).

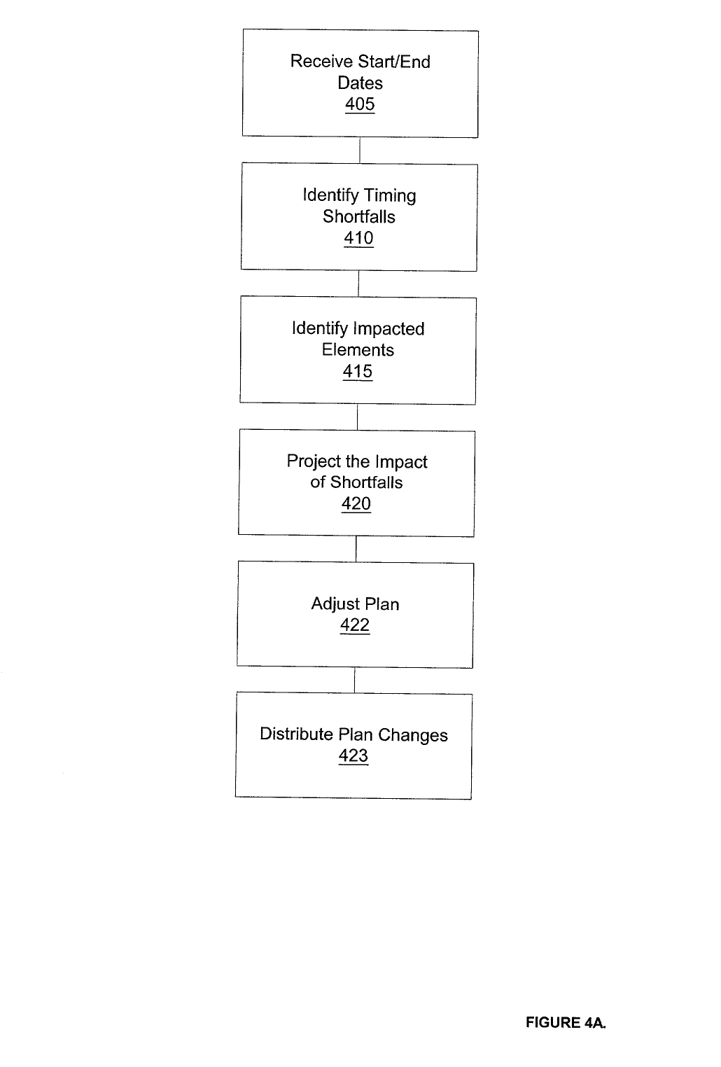

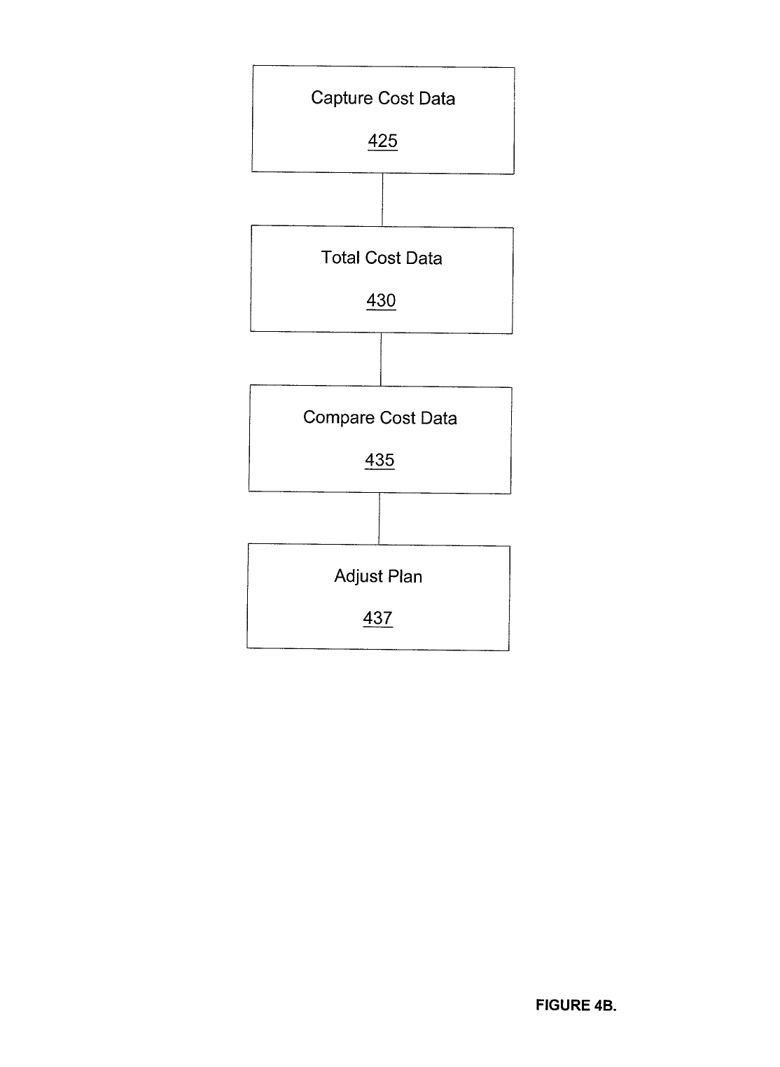

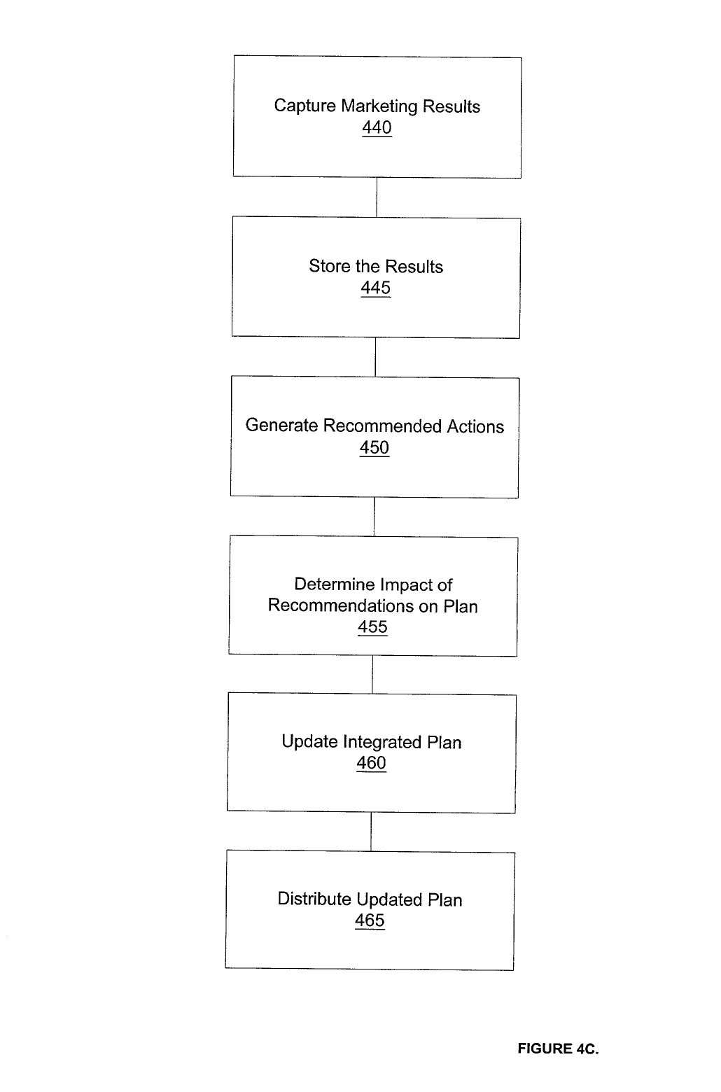

Referring now to FIGS. 4A-4C, there are illustrated a series of flowcharts detailing the various implementations of the step of managing (Step 115) as shown in FIG. 1. FIG. 4A, for example, relates to the timetable for implementing the marketing plan. That is, FIG. 4A illustrates the steps for projecting the impact that a delay in one action could have on other elements of a marketing plan. In this embodiment, the actual (and if necessary the projected) start and end dates for each action are collected (Step 405) and stored. Any actions that are overdue or late in starting/ending are identified (Step 410). Next, those elements of the marketing plan (e.g., actions, steps, tactics, programs, and/or campaigns) which could be impacted by the delayed action are electronically identified (Step 415), and the corresponding degree of the impact is calculated (Step 420). If necessary, a revised schedule accounting for the delay can be automatically generated by the software application of the present invention (Step 422). That is, particular actions can be assigned new start/end dates to accommodate for the delay. Notably, with this type of integrated managing system, a marketing professional can, for the first time, see in real time the impact that a delay at any level can have on an entire marketing plan. Once updated, the revised plan can be distributed to the appropriate personnel (Step 423).

Referring now to FIG. 4B, there is illustrated a flowchart of one method for monitoring expenditures across an entire marketing plan. In this embodiment, the actual costs associated with each action are recorded (Step 425). Using this data the costs for each action in a step can be accumulated to determine an overall costs of the corresponding step (Step 430). Likewise, the costs for each step in a tactic can be accumulated to determine an overall cost of the tactic; the costs for each tactic in a program can be accumulated to determine an overall cost for the program; the costs for each program in a campaign can be accumulated to determine an overall costs of the campaign; and the costs for each campaign in a marketing plan can be accumulated to determine an overall cost of the marketing plan.

In each of the above levels, the calculated costs can be compared against the budget to determine if any particular level is over budget or projected to be over budget (Step 435). Even if one level is over budget, its associated higher level might not be over budget. For example, particular actions or even tactics within a certain program and campaign may be over budget. The overall program/campaign, however, may still be on target due to cost savings in other actions. Because the expenditures throughout the entire marketing plan can be monitored, resources can be dynamically adjusted to compensate for any shortfalls. Should the overall marketing plan budget be exceeded, adjustments at the step or tactic level may be made (Step 437) and the plan updated.

Referring now to FIG. 4C, there is illustrated a flowchart of one method for analyzing marketing results. First, the actual/estimated marketing results are collected (Step 440). These results could include the percent of target audience reached, actual costs v. estimated costs, actual timetable v. projected timetable, etceteras. This information can be parsed, indexed and stored for future reference (Step 445). In particular, the information (in aggregate with the information from other marketing plans) can be used to recommend tactics, steps, actions, budgets, and/or timetables for subsequent marketing plans (Step 450). Should campaigns, programs, tactics or results inhibit the ability of the overall plan's goals (Step 455), then modification to the plan can be made and the modified plans distributed to the appropriate personnel (Step 465).

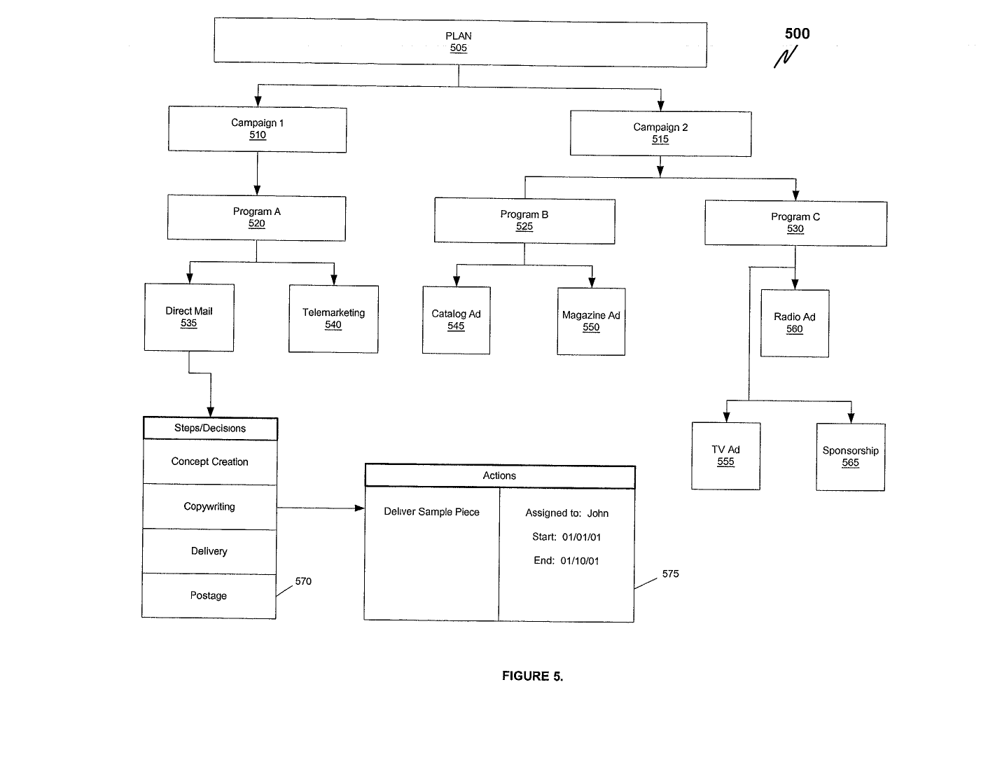

Referring now to FIG. 5, there is illustrated an exemplary data architecture diagram 500 constructed according to the principles of the present invention. This data architecture diagram illustrates the results of both the marketing plan generation Step 105 and the marketing plan implementation step 110 (both of FIG. 1). In particular, blocks 505-565 represent the data from the generation step, and blocks 570 and 575 represent the data from the implementation step 110. As can be appreciated by those of skill in the art, the data blocks are associated with each other in a basic tree format.

To better illustrate the relationships between the various data blocks and the generation and implementation of a multi-activity marketing plan, an example using real data is described. In this example, ACME has created a new insulating brick. Thus, the marketing plan 505 involves launching this new brick. For this particular plan 505, two campaigns 510, 515 have been defined. The object of the first campaign 510 is to increase awareness of the new brick and its manufacturer, and the object of the second campaign 515 is to promote sales of the brick. For the first campaign 510, a builder awareness program 520 is defined. The target of this program 520 is building contractors and the implementation involves two tactics: direct mail 535 and telemarketing 540. For the second campaign, two programs are defined: builder sales 525 and consumer sales 530. The builder sales program 525 is implemented through a catalog advertisement tactic 545 and a magazine advertisement tactic 550. Similarly, the consumer sales tactic 530 is implemented through three tactics: TV ads 555, radio ads 560, and sponsorships 565. In combination, these tactics, programs and campaigns define the overall marketing plan.

Referring now to blocks 570 and 575, they represent the data acquired during the implementation step 115 (shown in FIG. 1). For simplicity sake, the step block 570 for only one tactic (Direct Mail 535) and the action block 575 for only one step within that tactic are illustrated. Each tactic, however, could be associated with its own set of steps and each step associated with its own set of actions. In this example, the step block 570, is associated with the direct mail tactic and indicates those steps necessary to implement a direct mail tactic. Furthermore, the delivery step is associated with the action block 575 and, in particular, with the “deliver sample mail piece for approval” action. This particular action has been assigned to John and has a start date of 1/1/01 and an end date of 1/10/01.

Referring now to FIG. 6, there is illustrated a block diagram of the modules used to implement the various embodiments of the present invention. The first module is the Resource Data Module 605. This module contains, for example, the collected company information, the collected marketing team (personnel) information, vendor information and the like. Connected to the Resource Data Module 605 is the Communications Tools Module 610. This module can contain email, calendar tools, task list tools, threaded discussion tools—wired or wireless—, Internet access and/or intranet access. The presently preferred embodiment utilizes Microsoft Outlook™ to support some of these features.

In addition to being connected to the Communication Tools Module 610, the Resource Data Module 605 is also connected to the Marketing Plan Generation Module 615, which is responsible for implementing the marketing plan generation step 105 (shown in FIG. 1). The Marketing Plan Generation Module 615 is also connected to the Marketing Data Module 620 from which it draws data about projected targets, projected tactic results, etc. The Marketing Data Module 620 obtains such data through capturing tools that collect and combine the relevant data. As previously described, this data can be used to guide a marketing professional through the process of creating a marketing plan. Furthermore, the Marketing Planning Generation Module 615 is connected to the Marketing Plan Implementation Module 625, which is responsible for implementing the marketing plan implementation step 110 (shown in FIG. 1). Finally, the Marketing Plan Implementation Module 625 is connected to the Reporting Tools Module 630 and the previously-described Marketing Data Module 620. The Reporting Tools Module 630 is responsible for implementing the managing step 115 of FIG. 1. Moreover, the Reporting Tools Module 630 is responsible for identifying and transmitting any relevant data to the Marketing Data Module 620 for indexing and/or storage.

Referring now to FIG. 7, there is illustrated an exemplary embodiment of a hardware system 700 for implementing the modules shown in FIG. 6 and/or practicing the methods described with relation to FIGS. 1-3 and 4A-4C. In this embodiment, two server systems 705, 710 are connected by a network 715. Although these server systems can include any type of architecture and can be operable according to any type of operating system, e.g., Unix, Linux, Windows™, the presently preferred embodiment utilizes Windows™ and any Windows™ compatible architecture.

The modules of FIG. 6 can reside on a single server system 705 or can be distributed across multiple server systems 705, 710. For example, all of the modules with the exception of the Marketing Data Module 620 (shown in FIG. 1) could reside on server system 705, which is the customer's server system. The Marketing Data Module 620, accordingly, could reside on the server system 705, which is the host server system 710. Any interaction between the Marketing Data Module 620 and the other modules can be conducted through the interconnecting network 715.

Referring now to FIG. 8, there is illustrated a market model 800 constructed according to the principles of the present invention. The market model 800 is a user-constructed graphical representation of a marketing plan. In particular, the market model 800 enables a user to efficiently generate, manage and view a marketing plan. In particular, the market model 800 can be constructed of various inter-connectable objects. These objects and their connections, for example, can be selected from an object library and added to a market model template. In one embodiment, the objects can be added to the market model 800 by selecting an object from object holder 802 and dragging the selected object to the market model 800.

Three general classes of objects can be added to a market model: marketing, company and analysis. The individual objects included in the marketing class of objects are the defining elements that make up a marketing plan. Moreover, the marketing class of objects interact with each other by sharing information and attributes. Some marketing class objects exist independently within the space of the market model 800 and others are strictly hierarchical in nature. The company class of objects, on the other hand, contain the important aspects of the company (i.e., the company offering the service/product) that will impact the marketing strategy and results. Items such as business model, accounting practices, distribution constraints, and marketing methodology can be accounted for with this class of objects. Finally, the analysis class of objects are used to monitor and analyze the effectiveness and progression of a marketing campaign.

Referring first to the marketing class of objects, this class includes nine individual objects. Depending upon the implementation, however, a market model can incorporate fewer than nine objects. Moreover, additional classes of objects can be created to meet the goals of a particular project.

The first marketing class object is the plan object. The plan object is the strategic view of the marketing activities around a certain objective. Multiple plan objects can exist for a single marketing department. For example, a plan object can exist for each product that a company is marketing. With regard to the market model 800, the plan object is the template to which other objects are added. The data included in a plan object could be associated with the marketing plan data block 505 (shown in FIG. 5).

Each plan object can include a plurality of tier objects 802a-e. These tier objects 802 exist as children of the plan object. In particular, each tier object 802 is represented by a physical layer on the market model that represents the relationship between a target 804a-f and the company object 816 initiating the marketing activity. Each tier object can be predefined for known entities or custom developed for specific business models. For example, tier 1 could represent a distributor (802a), tier 2 (802b) could represent a reseller, and tier 3 could represent a partner (802c).

Still referring to FIG. 8, each tier object (802) can be associated with a plurality of target objects 804a-f, each of which exists as a child of a particular tier object (802). A target object 804 is directed towards the group whose needs can be met with the product or service being marketed. That is, the marketing campaign is designed to generate a specific response from the group defined by the target object 804. Target objects 804, for example, can represent individual customers such as Walmart™ or groups of customers such as value added resellers. Moreover, target objects 804 can include descriptions and values for the number of members or opportunities that exist within that target. Target objects 804 can also include a collection of attributes that define the relationship between the company and the target audience. For example, attributes can include timeframes, constraints (e.g., timeframe constraints, distributor sell through constraints, product education level of reseller), entity type, number of members in target audience, adoption curve of target audience, and/or product affinity. Some of these attributes can also be associated with a tier object 802.

A market model 800 can also include campaign objects 806a-e. The campaign objects 806 are children of the plan object and can have a peer relationship with a target object 804 and other campaign objects. Generally, a campaign object 800 is defined by a high-level message, overall objective, or strategy that contains a series of programs and tactics. Each campaign object 806 can be associated with an expanded view. Campaign object 806a illustrates such an expanded view. This expanded view can be used to view details about a campaign or to enter data about a campaign. The data of a campaign object 806 could be associated with one of campaign 510 or 515 as shown in FIG. 5.

Each campaign object can include program objects 808. Program objects 808 are children of an associated campaign object and can have peer relationships with other program objects 808. A program object 808 can provide a definition of specific objectives of the parent campaign. For example, the campaign objective may be represented by campaign 806a and the program object 808a can define a specific collection of tactics 810a-c that can achieve that goal. The data of a program object could be associated with, for example, program 520 (shown in FIG. 5).

Tactic objects 810 can be associated (as child objects) with each program object 808. The tactic objects 810 define the methods, means, and modes of marketing. For example, tactics can be associated with impressions, response rates, conversion rate assumptions, etc. Tactic object data can be associated with an appropriate tactic such as tactics 535-565 (shown in FIG. 5).

Each of the various objects can be connected by connector objects 812a-f that define the relationships between the various objects. The connector objects 812 can define the type of campaign, e.g., push or pull, and the relationship between the company, the targets, and the campaigns. For example, connector object 812b is associated with a push campaign 806d from target 804b to target 804c. Furthermore, groups of connector objects 812 can be associated with a channel model definitional block 814. This channel model includes attributes, constraints and other data about a particular marketing channel. For example, connector objects 812a, 812b, and 812c could define a marketing channel between the company object 816 and the target (prospect segment 2) 804e. If the size of the target 804e is 100,000 people, then the channel model 814 would reflect that constraint and pass it to connector objects 812a, 812b, and 812c. Each connector object 812a-c would be constrained by the 100,000 person limitations.

The marketing of class objects can also include a timeline object 818 and tactical dependency objects 820. The timeline object 818 can be created based upon the date values assigned to campaigns, programs and/or tactic objects. The tactical dependency object 820 represents the real world dependencies between activities. Tactical dependency objects, for example, can be input/output dependencies or time constraint dependencies.

Referring now to the company class of objects, this class includes three basic objects: company objects 816, product objects 824 and organization objects 826. The company objects 816 include the important aspects of the company (i.e., the company offering the product/service for which a marketing plan is being developed) that will impact the marketing strategy and results. Items such as business model, accounting practices, distribution constraints and marketing methodology can be accounted for within this object. The company object 816 is the parent to the plan object.

The product object 824 includes the definitions of the product, product line and/or service that the company offers. Moreover, the product object 824 can include deliverable requirements or milestones that constrain the overall marketing activities. The information in the product object 824 can be used to create financial models, market model configurations and tactical constraints. Moreover, a product object 824 can be associated with one or more campaign objects 806 and/or company objects 816.

Finally, the organizational object 826 includes an organization object that defines the roles, reporting relationships, areas of expertise, and authorities within the company, the marketing department, and/or the sales department. This relationship information can be used for assigning tasks to appropriate personnel. Additionally, this relationship information can be used to identify resource restraints that could impact the marketing timeline as defined in the timeline object 818.

The analysis class of objects, which can include marketing operation reporting objects 828a-e and marketing results reporting object 830, can be used to manage the marketing plan as defined by the marketing and company class of objects. Marketing operational reporting objects 828, for example, can be associated with various objects within a market model and can present status information about the campaigns, programs, steps, tactics and/or actions. In fact, each level of the market model 800 can include a marketing operational reporting object 828 that reports the status of that level. Thus, any level of the plan that is behind and/or over budget can be quickly identified.

A marketing results reporting object (such as marketing results reporting object 830) can be associated with each level of a campaign and can generate graphs or other output associated with each level of the market model 800. At the plan level, the marketing results reporting object can generate graphs that show the results of the campaign as compared to the projected results of the campaign. At the campaign level, the marketing results reporting object can chart the results of the underlying programs, and at the program level the marketing results reporting object can show the results of the individual tactics.

In conclusion, the present system provides, among other things, a method and apparatus for generating, implementing, managing and viewing a multi-activity marketing plan. Those skilled in the art, however, can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for generating a market model for a marketing activity associated with an enterprise, the method comprising the steps of:
defining a tier object representing a relationship between the enterprise and a target group;
defining a target object associated with the tier object, wherein the target object is associated with a target group;
defining a campaign object, wherein the campaign object is associated with an objective of the marketing activity;
defining a program object, wherein the program object is associated with the campaign object and wherein the program object corresponds to an objective of the campaign object;
defining a tactic object, wherein the tactic object is dependent upon the first program object; and
generating the market model using the tier object, the target object, the campaign object, the program object and the tactic object.

2. The method of claim 1, further comprising the steps of:
associating timing data with the tactic object; and
generating a timeline object based upon, at least, the timing data that is associated with the tactic object.

3. The method of claim 1, further comprising the steps of:
defining a company object; and
defining a connector object linking the company object and the target object.

4. The method of claim 3, wherein the company object comprises:
an organizational object.

5. The method of claim 3, further comprising the step of:
if associating the connector object with the campaign object.

6. The method of claim 1, further comprising the step of:
defining an analysis object.

7. The method of claim 6, wherein the analysis object comprises:
a marketing operational reporting object.

8. The method of claim 6, wherein the analysis object comprises:
a marketing results reporting object.

9. A method for generating a market model for a marketing activity associated with an enterprise, the method comprising the steps of:
defining a tier object representing a relationship between the enterprise and a target group;
defining a target object associated with the tier object, wherein the target object is associated with a target group;
defining a tactic object, wherein the tactic object is associated with the target object; and
generating the market model using the tier object, the target object, and the tactic object.

10. The method of claim 9, further comprising the step of:
defining a campaign object, wherein the campaign object is associated with an objective of the marketing activity.

11. The method of claim 10, further comprising the step of:
defining a program object, wherein the program object is associated with the objective of the marketing activity; and wherein the tactic object is associated with the program object.

12. The method of claim 9, further comprising the step of:
defining an organization object associated with the enterprise.

13. The method of claim 12, wherein the organization object is associated with the campaign object.

14. An article of manufacture comprising:
a computer readable medium;
a plurality of instructions stored on the computer readable medium, the plurality of instructions configured to cause a computer to:
define a tier object representing a relationship between an enterprise and a target group;
define a target object associated with the tier object, wherein the target object is associated with the tier object;
define a campaign object, wherein the campaign object is associated with the objective of the marketing activity;
define a program object, wherein the program object is associated with the campaign object and wherein the program object corresponds to an objective of the campaign object;
define a tactic object, wherein the tactic object is dependent upon the first program object; and
generate the market model using the tier object, the target object, the campaign object, the program object and the tactic object.

15. The article of manufacture of claim 14, wherein the plurality of instructions are further configured to cause the computer to:
associate timing data with the tactic object; and
generate a timeline object based upon, at least, the timing data that is associated with the tactic object.

16. The article of manufacture of claim 14, wherein the plurality of instructions are further configured to cause the computer to:
define a company object; and
define a connector object linking the company object and the target object.

17. The article of manufacture of claim 16, wherein the plurality of instructions are further configured to cause the computer to:
associate the connector object with the campaign object.

18. The article of manufacture of claim 14, wherein the plurality of instructions are further configured to cause the computer to:
define an analysis object.

19. A market model for managing a marketing activity associated with an enterprise, the market model comprising:
a tier object representing a relationship between the enterprise and a target group;
a target object associated with the tier object, wherein the target object is associated with a target group;
a campaign object, wherein the campaign object is associated with an objective of the marketing activity;
a program object, wherein the program object is associated with the campaign object and wherein the program object corresponds to the objective of the campaign object; and
a tactic object, wherein the tactic object is dependent upon the first program object.

20. The market model of claim 19, further comprising:
a company object; and
a connector object linking the company object and the target object.

21. The market model of claim 19, further comprising:
an analysis object.
